(19) United States
(12) Patent Application Publication
(10) Pub. No.: US 2007/0095476 A1
(43) Pub. Date: May 3, 2007

(54) Plasma discharger

(75) Inventors: Noboru Saeki, Osaka-shi, Osaka (JP); Terukazu Miyoshi, Osaka-shi, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignees: PEARL KOGYO CO., LTD., Osaka-shi, Osaka (JP); BBK BIO CORPORATION, Tokyo (JP)

(21) Appl. No.: 10/596,149

(22) PCT Filed: Aug. 31, 2004
(86) PCT No.: PCT/JP04/12519

§ 371 Date: Jun. 1, 2006

(30) Foreign Application Priority Data
Dec. 3, 2003 (JP) 2003-404010

(51) Int. Cl. C23F 1/00; B08B 6/00

(52) U.S. Cl. 156/345.43; 134/1.1

(57) ABSTRACT

A plasma discharger in which, even on a rotating disk-like workpiece, a uniform energy distribution can be obtained over a wide range is provided.

In a plasma discharger in which a pulse voltage is applied to a pair of rod-like discharge electrodes (6) (7) to produce a corona discharge between the discharge electrodes (6) (7), and the surface of a workpiece (W) is irradiated with excited species including plasma produced by the corona discharge, the pair of rod-like discharge electrodes (6) (7) are formed into an asymmetrical shape, and one discharge electrode (6) is formed into a substantially L-like shape. A pointed end (6a) of the discharge electrode (6) is located in an outer peripheral portion of the disk-like workpiece (W) which is treated while involving rotation, a bend-continuous basal end portion of the other discharge electrode (7) which is formed into a substantially V-like shape is located in a rotation center portion of the disk-like workpiece (W) which is treated while involving rotation, and the pointed end (6a) of one discharge electrode (6) and the pointed end (7a) of the other discharge electrode (7) are located at different phase heights on an axis along a plasma ejecting direction.

### TECHNICAL FIELD

The present invention mainly provides a plasma discharger which is to be applied to various surface treatments such as washing of organics adhering to the surface of a rotating disk-like workpiece, disinfection or sterilization, and etching, and more particularly relates to a plasma discharger of the corona discharge type in which a surface treatment such as modification is conducted by irradiating the surface of a workpiece with excited species such as excited molecules, radicals, or ions which are generated as a result of molecular dissociation due to plasma produced by a corona discharge.

### BACKGROUND ART

A plasma discharger of the corona discharge type has an advantage that the use of an ignition gas such as helium, argon, or hydrogen which is required in the case of a plasma surface treating method of the glow discharge type can be omitted, and improvement of the safety in use and reduction of the treatment cost due to a reduced gas consumption can be realized. Therefore, the method is often used in surface treatments such as surface modification.

Important factors in this kind of a plasma discharger of the corona discharge type are the amount, area, and uniformity of irradiation of excited species including plasma produced by a corona discharge, to the surface of a workpiece. As means for attaining these important factors, conventionally, employed is a method in which, for example, discharge electrodes in which their tip end portions are formed into a substantially V-like shape are symmetrically placed in a hollow insulating holder in a state where their pointed ends are in close proximity to each other, a middle space portion of the insulating holder is used as an air ejection port, and excited species including plasma are irradiated toward the surface of a workpiece by ejection of high-pressure and high-speed air from the air ejection hole (for example, see Patent Reference 1).

Patent Reference 1: Japanese Patent Application Laying-Open No. 2001-293363

### DISCLOSURE OF THE INVENTION

### Problems that the Invention is to Solve

In the plasma discharger in which the discharge electrodes formed into a substantially V-like shape are symmetrically placed in a state where their pointed ends are in close proximity to each other, because of concentric generation of discharge energy lines, and the air flow ejected from the air ejection port in a middle portion of the insulating holder, a state where the energy amount in the center portion of the air ejection port is largest, and, as more advancing toward the outer periphery, the energy amount is further reduced is attained. In the case where a surface treatment is conducted on a rotating disk-like workpiece, therefore, a situation in which a rotation center portion is intensively treated, and a peripheral portion is not sufficiently treated may occur. Consequently, there is a problem in that the treatment is conducted while a workpiece is horizontally moved, or the discharger is horizontally moved, whereby the discharger is complicated.

The invention has been conducted in view of the above-mentioned circumstances. It is an object of the invention to provide a plasma discharger in which, even on a rotating disk-like workpiece, a uniform energy distribution can be obtained over a wide range.

### MEANS FOR SOLVING THE PROBLEMS

In order to attain the object, the invention of claim 1 is a plasma discharger in which a pulse voltage is applied to a pair of rod-like discharge electrodes to produce a corona discharge between pointed ends of the discharge electrodes, and a surface of a workpiece is irradiated with excited species including plasma produced by the corona discharge, wherein the pair of rod-like discharge electrodes are formed into an asymmetrical shape, and the pointed end of one of the discharge electrodes, and the pointed end of another one of the discharge electrodes are located at different phase heights on an axis along a plasma ejecting direction.

Furthermore, the invention of claim 2 is characterized in that, in addition to the configuration of claim 1, the one discharge electrode is formed into a substantially L-like shape, the other discharge electrode is formed into a substantially V-like shape, and the pointed end of the discharge electrode which is formed into a substantially L-like shape is forwardly located in the plasma ejecting direction.

Moreover, the invention of claim 3 is characterized in that, in addition to the configuration of claim 2, the pointed end of the discharge electrode which is formed into a substantially L-like shape is located in an outer peripheral portion of the disk-like workpiece which is treated while involving rotation, and a bend-continuous basal end portion of the other discharge electrode which is formed into a substantially V-like shape is located in a rotation center portion of the disk-like workpiece which is treated while involving rotation.

In the invention, the disk-like workpiece which is to be treated while involving rotation is not restricted to a thin disk such as a wafer, and alternatively may be a shallow container which has a raised peripheral wall in the peripheral edge, or the like.

### EFFECTS OF THE INVENTION

According to the invention, the pair of rod-like discharge electrodes are formed into a asymmetrical shape, and the pointed end of one discharge electrode, and the pointed end of the other discharge electrode are located at different phase heights on the axis along the plasma ejecting direction. Therefore, a corona discharge is produced between the pointed end of one discharge electrode and a discharge electrode linear portion of the other discharge electrode, and hence the energy density in the pointed end side becomes higher. In the case where the disk-like workpiece involving rotation is treated, the circumferential velocity on an outer peripheral edge portion of the rotating disk-like workpiece is high, and that on the side of the rotation center is low. When the high energy density is located in an outer peripheral edge portion of a rotating member, therefore, the amount of energy to be applied to the whole disk-like workpiece can be uniformalized.

### BRIEF DESCRIPTION OF THE DRAWINGS

FIG. 1 is an extracted enlarged view of main portions.

FIG. 2 is a front view of a plasma discharger.

FIG. 3 is a side view of the plasma discharger.

### DESCRIPTION OF REFERENCE NUMERALS

6, 7 . . . discharge electrode (6a . . . pointed end of one discharge electrode (6), 7a . . . pointed end of other discharge electrode (7)), W . . . workpiece.

### BEST MODE FOR CARRYING OUT THE INVENTION

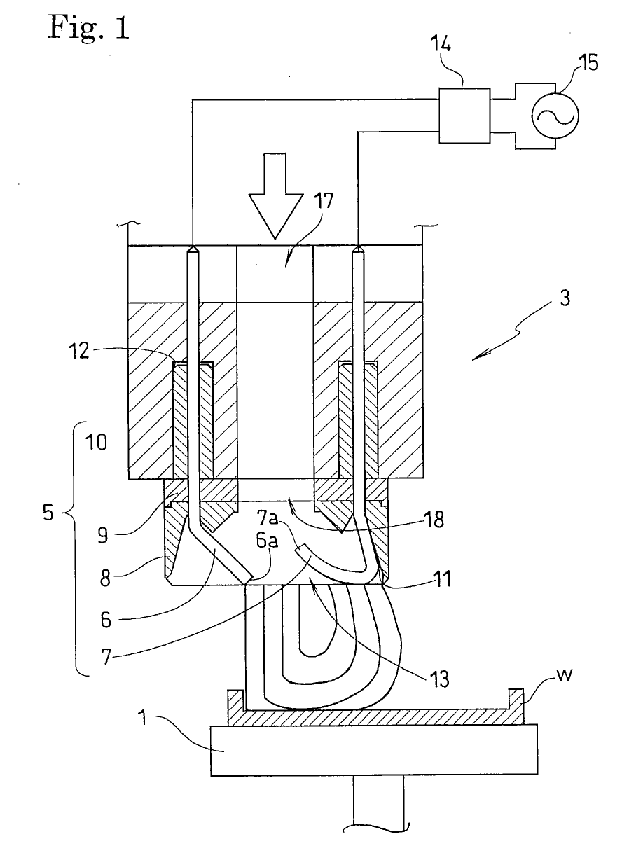

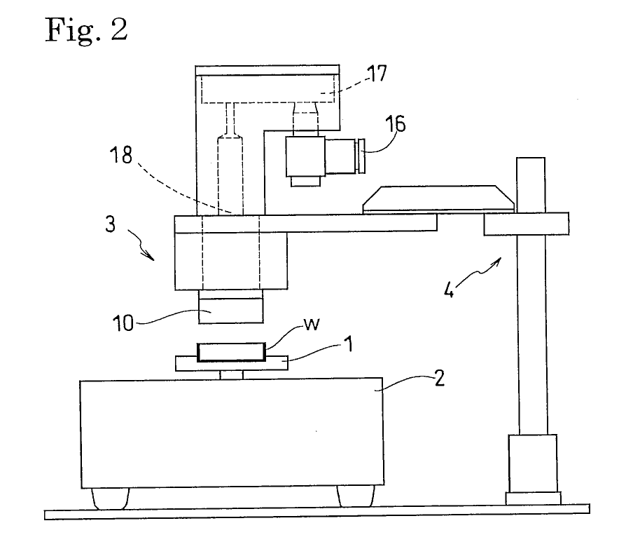

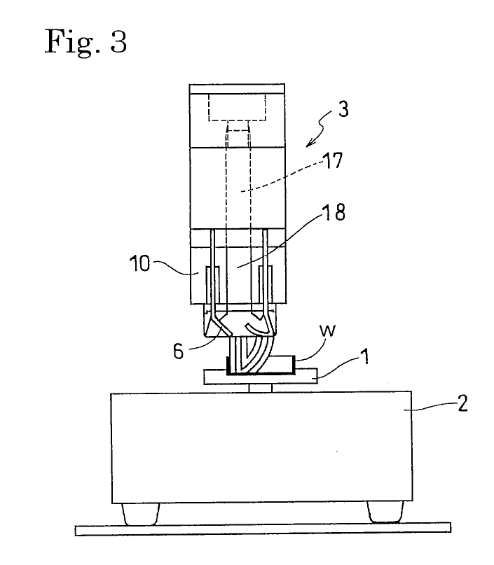

The figures show an embodiment of the invention, FIG. 1 is an extracted enlarged view of main portions, FIG. 2 is a front view of a plasma discharger, and FIG. 3 is a side view of the plasma discharger.

The plasma discharger is configured by: a platform (2) which comprises a rotation driving mechanism that is not shown, and in which a turntable (1) on which a disk-like workpiece (W) is to be mounted and fixed is projected from the upper face; a discharge head unit (3) which is opposed to the platform (2) from the upper side; and a support member (4) which supports the discharge head unit (3) in a vertically movable manner.

An electrode assembly (5) is formed in a lower end portion of the discharge head unit (3). The electrode assembly (5) has: a pair of discharge electrodes (6) (7); an insulative refractory material (8) in which an opening is formed, and which is made of ceramics (alumina); and an electrode support member (9) made of an insulative resin, and is attached to a head case (10) via the electrode support member (9). The insulative refractory material (8) and the electrode support member (9) are formed into a cylindrical shape.

In the insulative refractory material (8) and the electrode support member (9), through holes (11) (12) having a circular section are formed for receiving leg portions of the discharge electrodes (6) (7), and a channel-like opening (13) is formed in a tip end portion (lower end portion) of the insulative refractory material (8).

Each of the discharge electrodes (6) (7) is formed by a rod-like member which is bendingly formed, and which is made of tungsten or molybdenum. The one discharge electrode (6) is formed by bending the rod-like member into a substantially L-like shape, and the other discharge electrode (7) is formed by bending the rod-like member into a substantially V-like shape. A pointed end (6a) of the discharge electrode (6) which is formed into a substantially L-like shape is located in a portion of the tip end face of the insulative refractory material (8). Furthermore, a bend basal end portion of the other discharge electrode (7) which is formed into a substantially V-like shape is located in a portion of the tip end face of the insulative refractory material (8), and a pointed end (7a) is located in an inner side of the channel-like opening (13) which is formed in the insulative refractory material (8). Therefore, the pointed ends (6a) (7a) of the pair of discharge electrodes (6) (7) are located at different heights (phases) in the vertical directions of the insulative refractory material (8), and the pointed end (6a) of the discharge electrode (6) which is formed into a substantially L-like shape is opposed to a bend-continuous linear portion of the discharge electrode (7) which is formed into a substantially V-like shape.

The discharger is formed in a state where the center of the discharge head unit (3), and the rotation center of the turntable (1) which is located below the unit are eccentric with each other. The pair of discharge electrodes (6) (7) are formed so that the gap between the pointed end (6a) of the discharge electrode (6) which is formed into a substantially L-like shape, and the bend basal end portion of the discharge electrode (7) which is formed into a substantially V-like shape is approximately equal to the distance (rotation radius) from the rotation center of the workpiece mounted on the turntable (1) to the outer peripheral edge, the bend basal end portion of the discharge electrode (6) which is formed into a substantially V-like shape is located in a rotation center portion of the rotating disk-like workpiece (W), and the pointed end (6a) of the discharge electrode (6) which is formed into a substantially L-like shape is located in an outer peripheral edge portion of the disk-like workpiece (W).

Output terminals of a step-up transformer (14) are electrically connected to the upper ends of the leg potions of the discharge electrodes (6) (7) which are supported by the electrode support member (9), respectively. A high-frequency AC power source (15) is connected to the step-up transformer. In the discharge head unit (3), an introduction port (16) for a gas such as air, carbon dioxide, or argon is formed. The gas which is introduced from the gas introduction port (16) is introduced into a middle space (18) which is formed in the insulative refractory material (8) and the electrode support member (9), via a gas passage (17) formed in the discharge head unit (3), and then ejected as a gas flow from the discharge head unit (3) toward the workpiece (W).

The disk-like workpiece which is to be treated is not restricted to a thin disk such as a wafer, and alternatively may be a shallow container which has a raised peripheral wall in the peripheral edge, or the like. Various surface treatments such as those of, in the case where application of a coating composition or printing is performed on a resin such as polyethylene, polypropylene, or PTFE (polytetrafluoroethylene), modifying the water repellent property of the surface to the water-attracting property, washing away organics adhering to the surface of glass, ceramics, a metal, a semiconductor, or the like, conducting disinfection or sterilization, performing an etching process, and modification, and a treatment of the surface of liquid stored in a shallow container may be possible as the treatment using plasma emitted from the plasma discharger.

### EXAMPLES

A high-frequency power of 50 Hz to 100 kHz, preferably 20 to 80 kHz, and 2 to 15 kv is applied to the discharge electrodes (6) (7) made of tungsten to produce a corona discharge between the discharge electrodes (6) (7), and air of 40 to 100 liters/min. is supplied to the gas passage (17). The number of rotations of the turntable (1) on which the workpiece (W) is mounted and fixed was set to 1 to 2 rotations per second, and the workpiece (W) was irradiated with a plasma flow for about 3 to 5 seconds.

### INDUSTRIAL APPLICABILITY

The invention can be used in surface treatments such as those of modifying the surface of a resin, washing the surface of glass, ceramics, a metal, a semiconductor, or the like, conducting disinfection or sterilization, performing an etching process, and modification.

1. A plasma discharger in which a pulse voltage is applied to a pair of rod-like discharge electrodes (6) (7) to produce a corona discharge between said discharge electrodes (6) (7), and a surface of a workpiece (W) is irradiated with excited species including plasma produced by the corona discharge, wherein
said pair of rod-like discharge electrodes (6) (7) are formed into an asymmetrical shape, and a pointed end (6a) of one discharge electrode (6), and a pointed end (7a) of another discharge electrode (7) are located at different phase heights on an axis along a plasma ejecting direction.

2. A plasma discharger according to claim 1, wherein said one discharge electrode (6) is formed into a substantially L-like shape, said other discharge electrode (7) is formed into a substantially V-like shape, and said pointed end (6a) of the discharge electrode (6) which is formed into a substantially L-like shape is forwardly located in the plasma ejecting direction.

3. A plasma discharger according to claim 2, wherein said pointed end (6a) of said discharge electrode (6) which is formed into a substantially L-like shape is located in an outer peripheral portion of said disk-like workpiece (W) which is treated while involving rotation, and a bend-continuous basal end portion of the other discharge electrode (7) which is formed into a substantially V-like shape is located in a rotation center portion of said disk-like workpiece (W) which is treated while involving rotation.
